(19) United States
(12) Patent Application Publication
(10) Pub. No.: US 2021/0377220 A1
(43) Pub. Date: Dec. 2, 2021

(54) OPEN SESAME

(71) Applicant: Code 42 Software, Inc., Minneapolis, MN (US)

(72) Inventors: Matthew Anton Tiedeken, Minneapolis, MN (US); Thomas Anthony Lindquist, Minnetonka, MN (US)

(21) Appl. No.: 16/889,997

(22) Filed: Jun. 2, 2020

(51) Int. Cl. H04L 29/06

(52) U.S. Cl. CPC H04L 63/0263; H04L 63/107; H04L 63/108; H04L 63/105

(57) ABSTRACT

Disclosed in some examples are methods, systems, machine-readable mediums, and computing devices for improved network security for network-based services. A firewall service protecting one or more provider computing devices that providing the network-based service may block all traffic by default. This prevents any network intrusions. A client computing device wishing to access a network-based service contacts an authority computing device of the network-based service. If the client computing device is authenticated by the authority computing device, the authority device provides a network address of a provider computing device which provides the network-based service for the account that was authenticated. The authority computing device also sends a message to a firewall service providing the firewall for the provider computing device to open a temporary hole in the firewall for the client computing device.

### TECHNICAL FIELD

Embodiments pertain to network security. Some embodiments relate to improved network access techniques that enhance network security.

### BACKGROUND

Computing functions normally provided by private hardware and/or software are increasingly being provided as publicly available network-based services (often referred to as cloud-based services). To access these network-based services, computing devices of users exchange data over the network with computing resources in one or more datacenters that provide the network-based services. Network-based services are attractive to users and organizations as both the initial costs and the total costs of setting up and operating these services are typically lower due to resource-sharing and economies of scale.

The proliferation of network-based services also provides nefarious users and would-be data thieves with easier access to user data stored on these services due to the availability of access to the datacenters and the centralization of many different users. While these services may employ various security precautions to safeguard their networks, weaknesses in software and hardware may still allow some intrusions. For example, attackers may scan computing devices of the network-based services looking for vulnerabilities of the hardware and software that is executing.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a typical network security layout for a network-based service according to some examples of the present disclosure.

FIG. 2 illustrates an improved network security system for a network-based service according to some examples of the present disclosure.

FIG. 3 illustrates a method of an authority computing device according to some examples of the present disclosure.

FIG. 4 illustrates a flowchart of a method performed by a firewall service that protects one or more computing devices providing one or more network-based services according to some examples of the present disclosure.

FIG. 5 illustrates a flowchart of a method of a client computing device accessing a network-based service according to some examples of the present disclosure.

FIG. 6 is a block diagram illustrating an example of a machine upon which one or more embodiments may be implemented.

### DETAILED DESCRIPTION

One network security technique that network-based services employ is a firewall. A firewall monitors and controls incoming and outgoing network traffic based upon one or more security rules that allow or reject certain types or addresses of traffic. These security rules are typically limited to acting upon information obtainable from data headers of network protocols below the application layer in a TCP/IP network model or Open Systems Interconnect model. For example, the rules may inspect TCP, UDP, or IP headers from traffic such as source addresses, destination addresses, port numbers, packet types, and the like and apply rules to values in those headers to allow or reject traffic. Firewalls do not typically dynamically adapt, in real time, to a state of an application layer (e.g., whether the application is authenticated) as this state is typically not observable or understandable through the network. As such, firewalls have no way of knowing in advance what traffic is authenticated to access a particular network-based service. Thus, the firewall may let in some unauthorized traffic to allow an application to determine which traffic is authorized and which is not.

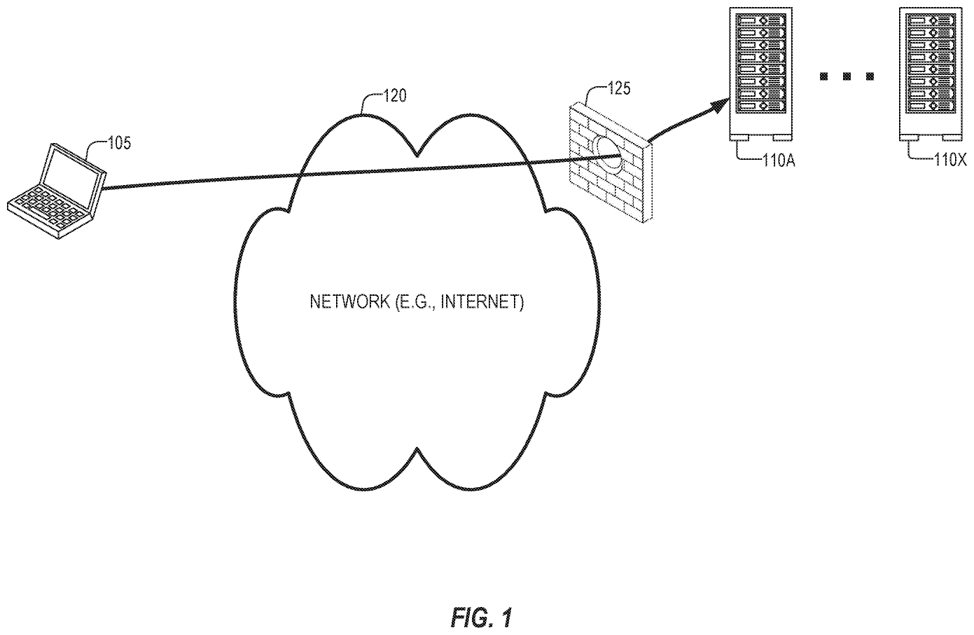

FIG. 1 illustrates a typical network security layout for a network-based service according to some examples of the present disclosure. Computing device 105 accesses one or more provider computing devices 110A-110X over network 120 and through firewall 125. Provider computing devices 110A-110X provide a network-based service to client computing devices such as computing device 105. For example, by executing one or more applications that communicate with one or more applications on computing device 105. Firewall 125 may filter out some types of traffic (e.g., such as traffic using certain protocols and/or on certain ports) and may have one or more blacklists that refuse traffic from select sources. Nevertheless, the firewall 125 needs to allow some traffic from most internet protocol (IP) addresses as firewall 125 does not know (at least initially) which traffic is authenticated and because most network-based services are designed to be accessible worldwide.

Typically, authentication is handled by an application executing on the provider computing devices 110A-110X or by another device behind firewall 125. If the computing device 105 is not authorized to access the services offered by the provider computing devices 110A-110X, the application on the provider computing devices may reject the computing device 105. While the computing device 105 is rejected, the computing device may try again and continue to probe the provider computing devices 110A-110X looking for vulnerabilities as the firewall 125 is not appraised of the failure of the computing device 105 to authenticate. Firewall 125 thus acts as a basic screening device that removes some harmful activity but not all harmful activity. Malicious actors are usually still able to scan and probe the provider computing devices 110A-110X looking for vulnerabilities and the task of preventing malicious intrusions falls to the provider computing devices 110A-110X.

Disclosed in some examples are methods, systems, machine-readable mediums, and computing devices for improved network security for network-based services. In some examples, a firewall service protecting one or more provider computing devices that provide the network-based service may block all traffic by default. This prevents any network intrusions. A client computing device wishing to access a network-based service first attempts to authenticate with an application on an authority computing device. The authority computing device is behind a different firewall that does not block all traffic. If the client computing device is authenticated by the authority computing device, the authority computing device sends a message to a firewall service providing the firewall for the provider computing device to grant access (“open a hole in the firewall”) through the firewall for the client computing device by, for example, allowing network traffic with a return address of the network address of the client computing device. This allows the firewall for the provider computing device to respond to an application state of an application of the provider computing device. In some examples, the address of the provider computing devices is known in advance by the client computing device. In other examples, the authority device provides a network address of a provider computing device in response to the successful authentication. In these examples, different provider computing devices may be dynamically chosen at authentication time, such as being load balanced.

The hole opened in the firewall may be temporary in that it may only be opened for a short period of time. In some examples, the firewall may not have to open a hole for received messages from the authority computing device as the authority computing device may be within a same private network as the computing device providing the service. In other examples, the firewall may have whitelisted the authority computing device—thus the firewall protecting the provider computing devices may default to denying all traffic from all source IP addresses except the authority computing device.

As the firewall defaults to rejecting all network traffic absent an authenticated computing device, attackers who attempt to scan or otherwise probe the computing device that is providing the service will not be able to scan or probe the computing device as packets sent to the computing device may be dropped by the firewall and may not be returned. The attacker may then wrongly assume that no computing device exists at that particular address. Moreover, by defaulting to dropping all packets and only allowing authenticated devices through the firewall, the firewall configuration and administration is nearly eliminated—which prevents intrusions through misconfigured firewalls. The benefits of this simple configuration become apparent when one considers a network-based service that may employ hundreds of different firewalls. In addition, because the firewall can consider the application state of the network-based service, the firewall may only allow legitimate, authenticated traffic through the firewall which reduces the security risks inherent in firewalls lacking application-level knowledge.

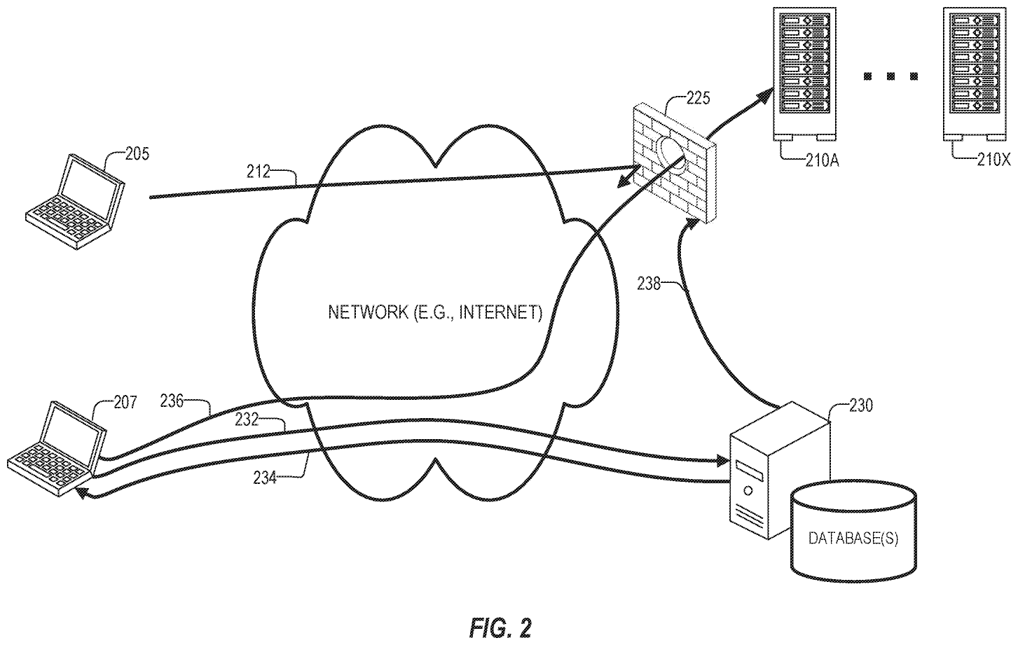

FIG. 2 illustrates an improved network security system for a network-based service according to some examples of the present disclosure. First computing device 205 does not first authenticate with the authority computing device 230. Thus, communications 212 of the first computing device 205 to provider computing devices 210A-210X will be dropped by the firewall service 225. For example, firewall service 225 could send a denial response, no response, or the like. In the case of sending no response, the first computing device 205 may not even be able to confirm that a computing device is present at the address that the communication 212 was sent to.

In contrast, a second computing device 207 first authorizes with the authority computing device 230 using communications 232. The address of the authority computing device 230 may be programmed into an application executing on the second computing device 207 or may be an address returned by a domain name server in response to a DNS query to a web address of the network-based service. In some examples, the authority computing device 230 may also authenticate with the second computing device 207. The communications 232 (and other communications shown in FIG. 2) may be secure communications, such as using Transport Layer Security (TLS).

In some examples, the authentication that happens with the authority computing device 230 may be a network level authentication. The authorized computing device sends one or more credentials associated with a particular device to the authority computing device. For example, a set of device specific credentials may be stored in an application for the network-based service downloaded by the second computing device 207. The credentials may be provisioned to the application by the system at the direction of an administrator and may be revoked by the system at the direction of an administrator at any time. For example, if the second computing device 207 is stolen, the administrator of the network-based service or an account administrator of the network-based service may revoke credentials associated with the second computing device 207. In that case, the second computing device 207 will fail to authenticate with the authority computing device 230 and will fail to be able to bypass the firewall service 225 as a result. These credentials may be a password, a cryptographic token, or the like. In some examples, the network credentials may be stored by the application on the second computing device 207 and may be automatically provided by the application when communicating with the authority computing device 230 without user input.

In other examples, simpler network credentials may be used, such as matching one or more network or device identifiers of the second computing device 207 to a list of authorized network identifiers. Network identifiers may include Internet Protocol (IP) addresses, or the like. Device identifiers include a serial number, Unique Device Identifier (UDID), or the like.

In examples in which the authentication that happens with the authority computing device 230 is a network level authentication, the second computing device 207 may still need to authenticate with the provider computing devices 210A-210X on an application level. For example, by providing a username and password of the account that the second computing device 207 intends to access. In these examples, there are two layers of authentication that additionally increase security.

In some examples, in addition to, or instead of, the network level authentication, the authority computing device 230 may authenticate a computing device on an application level. For example, the user's credentials to access their account on the network-based service may be checked to determine that the account they are trying to access is valid. For example, the user may enter their username and password and these credentials may be provided to the authority computing device 230. The authority computing device 230 may have access to the list of accounts that are authorized and their credentials and if the credentials given by the second computing device 207 match an authorized account, access may be granted.

In some examples, once authenticated with the authority computing device 230, access is granted to the provider computing devices 210A-210X and additional authentication is not needed (e.g., the authority computing device 230 may message the provider computing devices 210A-210X to grant access for second computing device 207). In other examples, the second computing device 207 may also authenticate with the provider computing devices 210A-210X using the same credentials. In still other examples, different user-entered application level credentials may be used for the authority device 230 and for the provider computing devices 210A-210X. In still additional examples, after authenticating with the authority computing device 230, the authority computing device 230 sends a code to the second computing device 207. The code may then be provided (either automatically by software on the second computing device 207, or manually by the user) to the provider computing devices 210A-210X. Separately, the authority computing device 230 sends the code to the provider computing devices 210A-210X. If the code provided by the second computing device 207 matches the one sent by the authority computing device 230, then the user is granted access by the provider computing devices 210A-210X.

In some examples, the authority computing device 230 may be a single sign on provider. In some examples, and as shown in FIG. 2, the authority computing device 230 may be on a different device than the provider computing devices 210A-210X, but in other examples, the functions of the authority computing device may be provided by a service on one or more of the provider computing devices 210A-210X.

In some examples, the authority computing device 230 may have access condition lists that specify conditions which must be met before devices are allowed to authenticate with and access the provider computing devices 210A-210X. The conditions may include a list of network and/or device identifiers that are always allowed access, network and/or device identifiers that are never permitted access. The conditions may be or include geolocations that are, or are not, allowed to access the provider computing devices 210A-210X. For example, computing devices that wish to authenticate with the authority computing device 230 may provide a geolocation. The authority computing device 230 may deny access (and not open a hole in the firewall 225) even if the computing device 230 properly authenticates if the geolocation is not allowed based upon the conditions. In addition, the authority computing device 230 may verify that the network address of the computing device seeking access matches the geolocation and deny access if the network address is not from the purported geolocation (e.g., they are using a Virtual Private Network (VPN), The Onion Router (TOR), or other concealment method). In still other examples, instead of, or in addition to geolocations a time of day may be utilized. Various conditions may be combined. For example, certain network addresses may be only allowed when within certain geolocations and during certain times. In another example, certain network addresses may not be allowed unless they are within a certain geolocation and during certain times. In some examples, an account of the user may have an authorization level and that authorization level may have certain conditions imposed on it to allow access. For example, one authorization level may restrict access to certain times, certain geolocations, certain addresses, and the like—whereas another authorization level may restrict access to different times, geolocations, addresses and the like.

In some examples, the conditions may be global for all clients of the network-based service, but in other examples, the conditions may be specific to each client. That is, a particular client may have certain network addresses (or range of addresses) that are not allowed to access the provider computing devices. For example, a defense contractor may not allow access from certain countries. Once the user authenticates with the authority, the authority computing device may retrieve a profile. The profile may list one or more access conditions that are then verified against the client computing device. If the client computing device meets the conditions, a hole in the firewall may be opened. If the client computing device does not meet the conditions, a hole may not be opened and access may be denied.

These conditions, when combined with only providing access to authenticated users allows for finer distinctions than a yes or no access decision. For example, the firewall may deny access unless the user authenticates at a particular authorization level, time of day, network address range. This is differentiated from standard whitelist/blacklists of firewalls because this is handled at a network level—that is, a denial result means that the service cannot be attacked, because it is not visible.

After authenticating the second computing device 207, the authority computing device 230 may determine one or more provider computing devices 210A-210X which may provide the network-based service to the second computing device 207. In some examples, the provider computing devices chosen may be based upon the identity of the account, device, network address of the device, and the like. In other examples, the provider computing devices may be chosen based upon load. In these examples, the authority computing device 230 may select a provider computing device (e.g., one or more of provider computing devices 210A-210X) that has a lowest amount of load, in a round-robin fashion, or the like.

In examples in which the authority computing device 230 selects a provider computing device based upon the identity of the user or their device, and in examples in which the authentication done by the authority computing device 230 is a network level authentication, the authority computing device 230 may maintain a list of provider computing devices 210A-210X for each device, group of devices, address, or groups of addresses. For example, accounts of the network-based service may have associated device and/or network ids and provider computing devices (such as one or more of the provider computing devices 210A-210X) that service that account.

In examples in which the authority computing device 230 selects a provider computing device based upon the identity of the user or their device, and in examples in which the authentication done by the authority computing device 230 is an application-level authentication, the authority computing device 230 may have a list of provider computing devices (e.g., one or more of computing devices 210A-210X) that provide the network-based service to the authenticated account. For example, the provider computing devices 210A-210X may provide a file storage service which may store one or more files of the second computing device 207 and the address that is provided may be an address of the provider computing device which stores the data for the second computing device 207.

In still other examples, the client computing device is configured with the addresses of the one or more provider computing devices 210A-210X to contact when the authentication with the authority computing device is successful.

Once the second computing device 207 is authenticated, authority computing device 230 may send a message 238 to the firewall service (e.g., firewall service 225) providing the firewall for the selected one or more provider computing devices (e.g., one or more of provider computing devices 210A-210X). The message 238 may include an address of the second computing device 207, identifiers of the provider computing device or devices that the authority computing device 230 has authorized the second computing device 207 to access, or the like. The message 238 may also include information on the account of the second computing device 207. Firewall service 225 may, by default, block all connections unless previously authorized by a message from the authority computing device 230.

In addition, one or more messages (not shown) may be sent directly to the one or more provider computing devices (e.g., one or more of provider computing devices 210A-210X) that are to handle the service for the second computing device 207. These messages may include information on the account of the second computing device 207 and may be used to prepare the authorized provider computing devices to service the second computing device 207. For example, the provider computing devices may begin initializing data structures, starting software applications, reserving resources, creating user interface descriptors (e.g., HTML, CSS, Javascript, java, etc.), and the like prior to an access request from the second computing device 207. By preparing for the imminent visit of the second computing device 207, the provider computing device may more quickly respond to the second computing device 207 once that device contacts the provider computing device.

In examples in which the second computing device 207 is not configured with the address of the provider computing devices that are to be contacted when authentication is successful with the authority computing device, the authority computing device 230 may send an address (e.g., an IP address) of one or more provider computing devices back to the second computing device 207 at 234. Second computing device 207 may then use the address of the provider computing device to contact that provider computing device to access the service provided by the provider computing device using communications 236. These communications 236 pass through the firewall 225 as a result of the previous message 238 sent by the authority computing device. The hole in the firewall may be for a limited time or may be left open so long as there is recent active communications between the second computing device 207 and the provider computing devices 210A-210X—e.g., the last communication between the second computing device 207 and the provider computing devices 210A-210X is more recent than a threshold amount of time. The limited time may be static, or may be determined by the authority computing device. In some examples, the hole may be closed by explicitly revoking the access. For example, the firewall service 225, provider computing devices 210A-210X, or the authority computing device 230 may detect access patterns and/or network traffic that matches one or more nefarious patterns of access and may explicitly revoke the access of second computing device 207. In some examples, a message to the firewall service 225 may be used to revoke an authorized computing devices access. After receipt of a revoke message, the hole will be closed and messages from the second computing device 207 are blocked.

As noted, the hole in the firewall may close after a predetermined period of time or a predetermined period of inactivity. The predetermined period may be static and determined by an administrator of the network-based service, or may be determined dynamically by the authority computing device. For example, certain accounts of certain users may have configurable time out settings. In other examples, the system may learn, through past usage history, an average session length and calculate the period based upon the average session length (e.g., set it to the average session length, or an amount greater than or less than the average session length). In still other examples, the predetermined period may be based upon geolocation of the computing device accessing the network-based service. For example, certain geolocations may be thought of as more risky and may have subsequently lower timeout lengths. For example, each geolocation may be associated with a timeout length, with different geolocations having potentially different timeout lengths.

In some examples, firewall 225 may be a single firewall for all provider computing devices 210A-210X and may be provided by one or more of the provider computing devices or a separate computing device. In other examples, firewall 225 may be specific to a particular provider computing device 210A-210X and may be provided by one or more of the provider computing devices 210A-210X or a separate computing device. In some examples, the message 238 from the authority computing device 230 may only open a hole to specific ones of the provider computing devices 210A-210X.

In examples in which the firewall 225 services multiple provider computing devices, the firewall will allow communications between the second computing device 207 and only those provider computing devices that were selected by the authority computing device 230. Attempts by the second computing device 207 to access provider computing devices 210A-210X that are not approved by the authority computing device 230 will be blocked. In examples in which the firewall 225 is specific to each provider computing device, the message 238 will only be sent to those specific provider computing device firewalls assigned by the authority computing device 230. Thus, the hole opened in the firewall 225 is not only specific to the second computing device 207 but also the provider computing devices 210A-210X.

As previously noted, the message 234 may include an identifier of one or more provider computing devices 210A-210X. In some examples, this identifier may be an IP address of one or more of the provider computing devices 210A-210X. In other examples, the identifier may be a non-network-routable identifier (e.g., it cannot be used by itself to route communications to the provider computing device) that is then translated by an application of the network-based service executing on the second computing device 207 to a routable network address. This application may be downloaded by authorized computing devices from the network-based service, an application repository (e.g., an app store), or the like. The application may translate the non-network-routable identifier into a network address based upon a list stored in the app. The list may be encrypted or otherwise secured by the app.

In some examples, the network addresses of the provider computing devices 210A-210X may be periodically updated. That is, periodically the addresses may be changed and in response, the list in the application may be updated. In some examples, the list in the application is only updated after authenticating that a user of the device on which the application is executing has a valid account on the network-based service. Thus, if the network-based service has a pool of network addresses where the size of the pool is greater than the number of provider computing devices 210A-210X, an attacker will have trouble ascertaining the pool of addresses and also will not know which address is currently assigned to which machine.

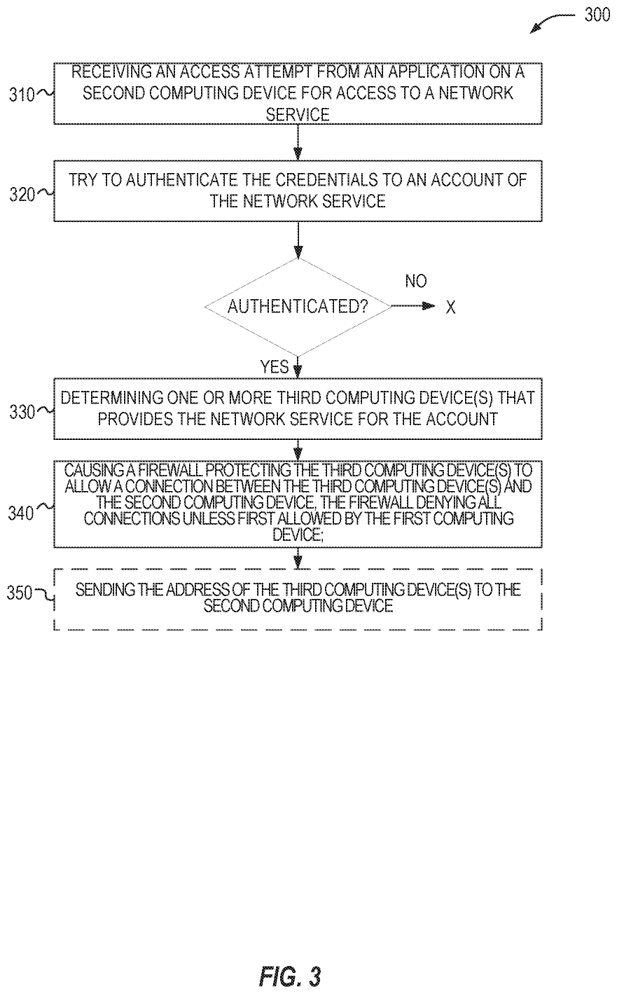

FIG. 3 illustrates a method 300 of an authority computing device according to some examples of the present disclosure. At operation 310, the authority computing device may receive an access attempt from an application on a second computing device for access to a network-based service. The application may be specific to the network-based service or may be a general application (e.g., such as a web-browser) that is able to access multiple different network-based resources and/or services. The access attempt may be via a specific application programming interface (API), may be using an HTTP REST protocol, or the like. In some examples, the access attempt may be a series of multiple messages exchanged between the authority computing device and the second computing device. In some examples, authentication credentials are sent by the second computing device (either directly or via a third party).

At operation 320 the authority device may authenticate the access attempt to an account of an authorized user and/or device of the network-based service. For example, the authority may have access to a database of valid accounts and may ensure that the second computing device has valid credentials or a valid network or device identifier. If the second computing device does not have valid credentials, network identifier, and/or device identifier, the second computing device may be rejected and processing of the method 300 may end.

At operation 330 the authority device may determine one or more third computing devices that provide the network-based service to the account that was authenticated. For example, if the network-based service is a file storage or sharing server, the files belonging to that account may be on a set of one or more computing devices that are a subset of a larger set of computing devices that provide network-based services (including other sets that provide the network-based services to other computing devices). In these examples, the account information retrieved by the authority may have an indicator of the computing devices that provide the service for the account. In other examples, the one or more third computing devices may be chosen from a pool of computing devices based upon load balancing criteria, such as an amount of free resources such as processor utilization, memory, or the like. The authority may access a list of computing devices that are operational and their resource status. For example, the authority may query the computing devices and determine their resource statuses and select one or more of them that has the lowest current resource utilization. In still other examples, the authority device may choose a computing device based upon a round-robin approach. The address of the one or more third computing devices may also be determined (e.g., a list of computing devices may include the addresses of the computing devices).

At operation 340 the authority may cause one or more firewalls protecting the one or more third computing devices to allow a connection between the one or more third computing devices and the second computing device. As previously noted, the firewall denies all connections (except, in some examples, from the authority computing devices) unless authorized by the authority. For example, the authority computing device may send a message to a firewall service operating directly on the one or more third computing devices, or send a message to another computing device that is performing the firewall function for the one or more third computing devices. The message may include the network address (e.g., the IP address) of the second computing device. In examples in which the firewall services multiple computing devices, the message may include the list of destination computing devices. That is, the firewall is only opened for a specific connection between specific machines. At operation 350, in some examples, the authority may send the address(es) of the one or more third computing devices to the second computing device. The second computing device may use the address(es) of the third computing device(s) to access the network-based service. In other examples, the application on the second computing device may already be configured with the proper addresses.

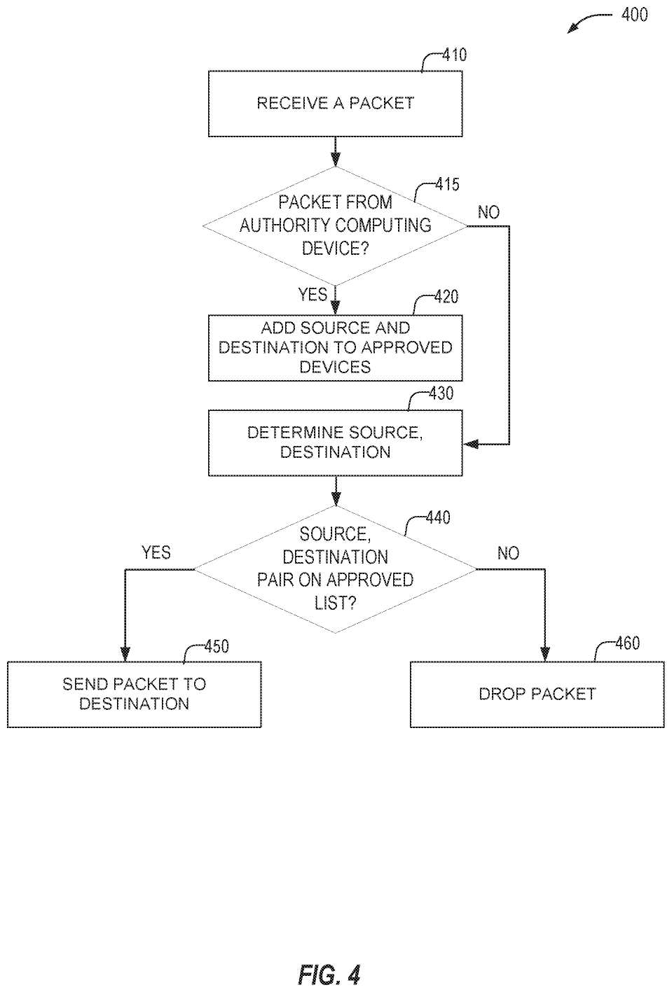

FIG. 4 illustrates a flowchart of a method 400 performed by a firewall service that protects one or more computing devices providing one or more network-based services according to some examples of the present disclosure. At operation 410 a packet is received. The packet may be received from a device over an external network (such as the Internet), or may be received from another device within a private network (e.g., an extranet or intranet in which only devices authorized to communicate over the extranet and/or intranet may be assigned network addresses that are specific to the extranet or intranet). The firewall service may determine whether the packet is from an authority computing device at operation 415. The firewall service may use the return address to determine that the message originated from the authority computing device. In addition, genuine messages from the authority computing device may be digitally signed by the authority computing device. For example, the message may include a keyed-hash message authentication code (HMAC) that may both verify the data integrity and authenticity of the message.

At operation 420, if the packet is from the authority computing device then the packet is reassembled with other packets from the message, authenticated, and if the message is authentic, then a hole is made in the firewall for the computing devices specified by the message from the authority computing device. In some examples, this is done by making an entry in an approved list (e.g., a white list) in a database. The entry may include the addresses of the client device and/or the provider computing device(s) that are provided in the message from the authority computing device. The current time may also be recorded.

If, at operation 430, the packet is not from an authority computing device, then the source of the packet and the destination are determined. For example, by observing packet headers of the packet. At operation 440 a determination is made whether the source and destination are on the approved list. If not, then at operation 460 the packet is dropped without a response. If it is on the list, then at operation 450, the packet is sent to the destination.

In examples in which the hole in the firewall is only open so long as the connection remains active, then the firewall may also verify, prior to sending the packet at operation 450, whether the last communication between the devices is within a predetermined period of time. If so, then the packet is sent to the destination at operation 450, otherwise, it may be dropped at operation 460 and the source and destination may be dropped from the approved list. If the last communication between the devices is within the predetermined period of time, the last access time stored in the approved list is overwritten with the current time.

In examples in which the hole in the firewall is only open for a limited time, then the firewall may also verify, prior to sending the packet at operation 450, whether the time recorded in the approved list is within a predetermined period of time from the current time. If so, then the packet is sent to the destination at operation 450, otherwise, it may be dropped at operation 460 and the source and destination may be dropped from the approved list.

In still other examples, instead of, or in addition to checking timing when packets are received, the firewall may periodically audit the list of approved devices to determine whether the communications are active (e.g., the last communication is within a predetermined period of time of when the periodic audit is taking place) or whether the firewall hole has expired (in the case of the hole being open only for a predetermined period of time regardless of the activity level). Those approved devices that fail the audit may be removed from the list of approved devices.

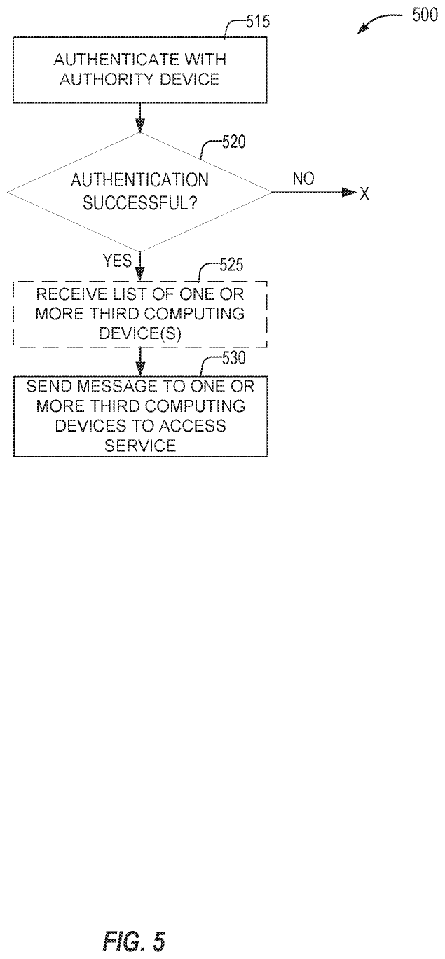

FIG. 5 illustrates a flowchart of a method 500 of a client computing device accessing a network-based service according to some examples of the present disclosure. At operation 515 the client computing device may authenticate with the authority computing device. For example, the client computing device may have a client application that knows the network address of the authority computing device. In other examples, a web-address is resolved to the IP address (e.g., through a Domain Name Service) to the authority computing device. The client computing device may then establish a secure connection with the authority computing device (e.g., a Secure Socket Layer connection) and transfer the credentials to the authority computing device. In some examples, the credentials may be network-level credentials or application layer credentials. In other examples, the credentials may be one or more network or device identifiers that may be provided by a packet return address header. At operation 520 a determination is made if the authentication was successful. If not, then the operations terminate. If the authentication was successful, in some examples, the client computing device may optionally receive a list of one or more third computing devices at operation 525. In other examples, the client computing device may already have the addresses of one or more third computing devices programmed in. This list may be encrypted as part of the secure connection, or may be encrypted separately or in addition to the secure connection. At operation 530, the client computing device may send a message to one or more third computing devices to access the service. These messages may pass through one or more firewalls that were opened for the client computing device by the authority computing device.

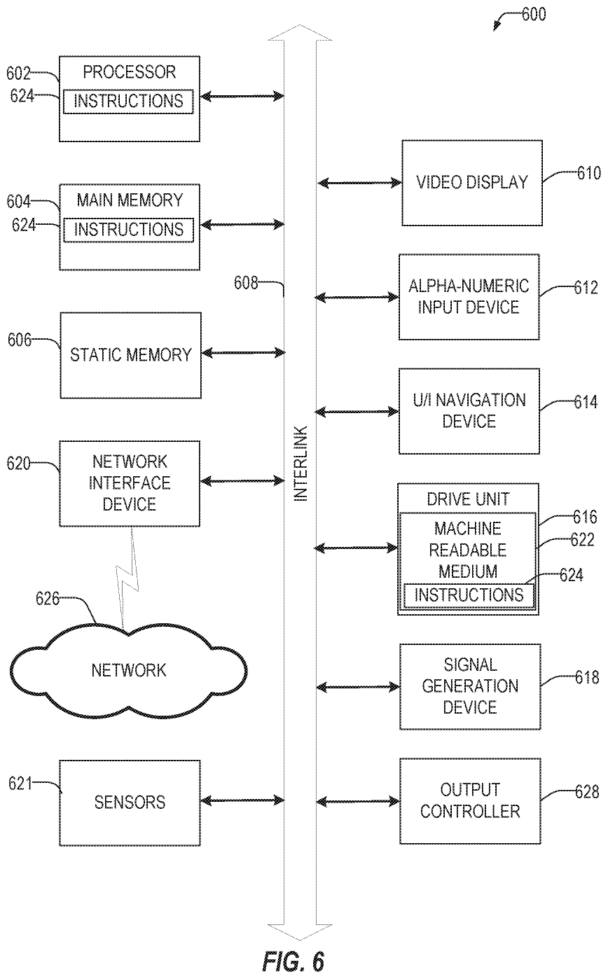

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. One or more of machine 600 may implement a network-based service (e.g., as an example of one or more of the provider computing devices 110A-110X, 210A-210X), a firewall service (such as firewall 125, 225), an authority computing device (such as authority computing device 230), and computing devices 105, 205, and 207. The machine 600 may perform one or more of the methods shown in FIGS. 3-5. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®. IEEE 802.16 family of standards known as WiMax@). IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

### OTHER NOTES AND EXAMPLES

Example 1 is a method for network security, the method comprising: at a first computing device: receiving, over a network, an access request from an application on a second computing device for access to a network-based service; authenticating the second computing device; determining a third computing device, the third computing device providing the network-based service; and causing a firewall protecting the third computing device to allow a connection between the third computing device and the second computing device, the firewall denying all connections unless first allowed by the first computing device.

In Example 2, the subject matter of Example 1 includes, sending an address of the third computing device to the second computing device.

In Example 3, the subject matter of Examples 1-2 includes, wherein the causing the firewall protecting the third computing device to allow a connection between the third computing device and the second computing device comprises allow the connection between the third computing device and the second computing device for a limited time, and wherein the firewall denies the connection from the second computing device after the limited time.

In Example 4, the subject matter of Examples 1-3 includes, wherein the firewall denies the connection from the second computing device after a predetermined period of not receiving a communication from the second computing device.

In Example 5, the subject matter of Examples 1-4 includes, wherein the firewall is provided by a service of the third computing device.

In Example 6, the subject matter of Examples 1-5 includes, wherein the network-based service is a file access service.

In Example 7, the subject matter of Examples 1-6 includes, wherein the method further comprises: responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and determining that the second computing device meets the access conditions and wherein the causing the firewall protecting the third computing device to allow a connection between the third computing device and the second computing device is done responsive to determining that the second computing device meets the access conditions.

Example 8 is a computing device for network security, the computing device comprising: a processor; a memory, the memory storing instructions, which when executed by the processor, cause the computing device to perform operations comprising: receiving, over a network, an access request from an application on a second computing device for access to a network-based service; authenticating the second computing device; determining a third computing device, the third computing device providing the network-based service; and causing a firewall protecting the third computing device to allow a connection between the third computing device and the second computing device, the firewall denying all connections unless first allowed by the computing device.

In Example 9, the subject matter of Example 8 includes, wherein the operations further comprise: sending an address of the third computing device to the second computing device.

In Example 10, the subject matter of Examples 8-9 includes, wherein the operations of causing the firewall protecting the third computing device to allow the connection between the third computing device and the second computing device comprises causing the firewall protecting the third computing device to allow the connection between the third computing device and the second computing device for a limited time, and wherein the firewall denies the connection from the second computing device after the limited time.

In Example 11, the subject matter of Examples 8-10 includes, wherein the firewall denies the connection from the second computing device after a predetermined period of not receiving a communication from the second computing device.

In Example 12, the subject matter of Examples 8-11 includes, wherein the firewall is provided by a service of the third computing device.

In Example 13, the subject matter of Examples 8-12 includes, wherein the network-based service is a file access service.

In Example 14, the subject matter of Examples 8-13 includes, wherein the operations further comprise responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and determining that the second computing device meets the access conditions and wherein the causing the firewall protecting the third computing device to allow a connection between the third computing device and the second computing device is done responsive to determining that the second computing device meets the access conditions.

Example 15 is a system for network security, the system comprising: a first computing device comprising: a processor; a memory, the memory storing instructions, which when executed by the processor, cause the first computing device to perform operations comprising: receiving, over a network, an access request from an application on a second computing device for access to a network-based service; authenticating the second computing device; determining a third computing device, the third computing device providing the network-based service; and sending a message causing a firewall device protecting the third computing device to allow a connection between the third computing device and the second computing device, the firewall device denying all connections unless first allowed by the first computing device; and the firewall device, comprising: a second processor; a second memory, the second memory storing second instructions, which when executed by the second processor, cause the firewall device to perform second operations comprising: maintaining a list of allowed traffic to the third computing device, the list of allowed traffic being initially empty; blocking all network traffic to the third computing device that is not on the list of allowed traffic; receiving from the first computing device the message to allow the connection between the third computing device and the second computing device; responsive to receiving the message from the first computing device, storing a source address of the third computing device and a source address of the second computing device in the list of allowed traffic; and subsequent to receiving from the first computing device the message, allowing traffic from the second computing device to the third computing device for a limited time, and upon expiry of the limited time, removing the source address of the third computing device and a source address of the second computing device in the list of allowed traffic such that subsequent network traffic from the second computing device is blocked unless another message is first received from the first computing device to allow the traffic.

In Example 16, the subject matter of Example 15 includes, wherein the operations executed by the processor further comprise sending an address of the third computing device to the second computing device.

In Example 17, the subject matter of Examples 15-16 includes, wherein the firewall device is the third computing device.

In Example 18, the subject matter of Examples 15-17 includes, wherein the operations executed by the second processor further comprise: responsive to receiving from the first computing device the message and prior to being contacted by the second computing device, performing one or more of: initializing a data structure used to service an expected request from the second computing device; starting a software application used to service the expected request from the second computing device; reserving computing resources to service the expected request from the second computing device; or creating a user interface descriptor to service the expected request from the second computing device.

In Example 19, the subject matter of Examples 15-18 includes, wherein the network-based service is a file access service.

In Example 20, the subject matter of Examples 15-19 includes, wherein the operations executed by the processor further comprise responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and determining that the second computing device meets the access conditions and wherein the causing the firewall device protecting the third computing device to allow a connection between the third computing device and the second computing device is done responsive to determining that the second computing device meets the access conditions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for network security, the method comprising:
at a first computing device:
receiving, over a network, an access request from an application on a second computing device for access to a network-based service;
authenticating the second computing device;
determining a third computing device, the third computing device providing the network-based service; and
causing a firewall protecting the third computing device to allow a connection between the third computing device and the second computing device, the firewall denying all connections unless first allowed by the first computing device.

2. The method of claim 1, further comprising:
sending an address of the third computing device to the second computing device.

3. The method of claim 1, wherein the causing the firewall protecting the third computing device to allow a connection between the third computing device and the second computing device comprises allow the connection between the third computing device and the second computing device for a limited time, and wherein the firewall denies the connection from the second computing device after the limited time.

4. The method of claim 1, wherein the firewall denies the connection from the second computing device after a predetermined period of not receiving a communication from the second computing device.

5. The method of claim 1, wherein the firewall is provided by a service of the third computing device.

6. The method of claim 1, wherein the network-based service is a file access service.

7. The method of claim 1, wherein the method further comprises:
responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and
determining that the second computing device meets the access conditions and wherein the causing the firewall protecting the third computing device to allow a connection between the third computing device and the second computing device is done responsive to determining that the second computing device meets the access conditions.

8. A computing device for network security, the computing device comprising:
a processor;
a memory, the memory storing instructions, which when executed by the processor, cause the computing device to perform operations comprising:
receiving, over a network, an access request from an application on a second computing device for access to a network-based service;
authenticating the second computing device;
determining a third computing device, the third computing device providing the network-based service; and
causing a firewall protecting the third computing device to allow a connection between the third computing device and the second computing device, the firewall denying all connections unless first allowed by the computing device.

9. The computing device of claim 8, wherein the operations further comprise:
sending an address of the third computing device to the second computing device.

10. The computing device of claim 8, wherein the operations of causing the firewall protecting the third computing device to allow the connection between the third computing device and the second computing device comprises causing the firewall protecting the third computing device to allow the connection between the third computing device and the second computing device for a limited time, and wherein the firewall denies the connection from the second computing device after the limited time.

11. The computing device of claim 8, wherein the firewall denies the connection from the second computing device after a predetermined period of not receiving a communication from the second computing device.

12. The computing device of claim 8, wherein the firewall is provided by a service of the third computing device.

13. The computing device of claim 8, wherein the network-based service is a file access service.

14. The computing device of claim 8, wherein the operations further comprise responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and
determining that the second computing device meets the access conditions and wherein the causing the firewall protecting the third computing device to allow a connection between the third computing device and the second computing device is done responsive to determining that the second computing device meets the access conditions.

15. A system for network security, the system comprising:
a first computing device comprising:
a processor;
a memory, the memory storing instructions, which when executed by the processor, cause the first computing device to perform operations comprising:
receiving, over a network, an access request from an application on a second computing device for access to a network-based service;
authenticating the second computing device;
determining a third computing device, the third computing device providing the network-based service; and
sending a message causing a firewall device protecting the third computing device to allow a connection between the third computing device and the second computing device, the firewall device denying all connections unless first allowed by the first computing device; and
the firewall device, comprising:
a second processor;
a second memory, the second memory storing second instructions, which when executed by the second processor, cause the firewall device to perform second operations comprising:
maintaining a list of allowed traffic to the third computing device, the list of allowed traffic being initially empty;
blocking all network traffic to the third computing device that is not on the list of allowed traffic;
receiving from the first computing device the message to allow the connection between the third computing device and the second computing device;
responsive to receiving the message from the first computing device, storing a source address of the third computing device and a source address of the second computing device in the list of allowed traffic; and
subsequent to receiving from the first computing device the message, allowing traffic from the second computing device to the third computing device for a limited time, and upon expiry of the limited time, removing the source address of the third computing device and a source address of the second computing device in the list of allowed traffic such that subsequent network traffic from the second computing device is blocked unless another message is first received from the first computing device to allow the traffic.

16. The system of claim 15, wherein the operations executed by the processor further comprise sending an address of the third computing device to the second computing device.

17. The system of claim 15, wherein the firewall device is the third computing device.

18. The system of claim 15, wherein the operations executed by the second processor further comprise:
responsive to receiving from the first computing device the message and prior to being contacted by the second computing device, performing one or more of: initializing a data structure used to service an expected request from the second computing device; starting a software application used to service the expected request from the second computing device; reserving computing resources to service the expected request from the second computing device; or creating a user interface descriptor to service the expected request from the second computing device.

19. The system of claim 15, wherein the network-based service is a file access service.

20. The system of claim 15, wherein the operations executed by the processor further comprise responsive to authenticating the second computing device, identifying one or more access conditions, the access conditions comprising one or more of: a list of allowable network identifiers, a list of prohibited network identifiers, a list of allowed geolocations, a list of prohibited geolocations, a list of allowed times of day, a list of prohibited times of day; and
determining that the second computing device meets the access conditions and wherein the causing the firewall device protecting the third computing device to allow a connection between the third computing device and the second computing device is done responsive to determining that the second computing device meets the access conditions.
